(19) United States
(12) Patent Application Publication
(10) Pub. No.: US 2007/0101409 A1
(43) Pub. Date: May 3, 2007

(54) Exchange of device parameters during an authentication session

(75) Inventors: Ashwin Palekar, Sammamish, WA (US); Hakan Berk, Bellevue, WA (US); Mudit Goel, Redmond, WA (US)

Correspondence Address: MERCHANT & GOULD (MICROSOFT), P.O. BOX 2903, MINNEAPOLIS, MN, 55402-0903, US

(73) Assignee: Microsoft Corporation, Redmond, WA (US)

(21) Appl. No.: 11/264,439

(22) Filed: Nov. 1, 2005

(51) Int. Cl. H04L 9/32; G06F 15/16; G06F 12/14; G06F 11/00; G06F 15/173; G06K 9/00; G06F 17/00; G06F 11/30; G06F 17/30; G06F 9/00; G06F 12/16; G06F 15/18; G06F 7/04; G08B 23/00; G06F 7/58; G06K 19/00

(52) U.S. Cl. 726/4; 726/24; 713/188; 726/25; 726/11; 709/225

(57) ABSTRACT

Methods of obtaining information during an authentication session. Information may be obtained, during the authentication session, about a device that is attempting to connect to a network. The information that is obtained may be related to health parameters of the device, or any other suitable information. Obtaining this information during an authentication session may enable determining whether to allow the device to connect to the network.

### BACKGROUND OF INVENTION

1. Field of Invention

The invention is related to communicating between devices during an authentication session.

2. Discussion of Related Art

Authentication methods provide network security by verifying credentials when a device attempts to connect to a network. In response to a request, the device sends either user credentials related to a user of the device or machine credentials related to the device itself. In addition, other information related to the authentication (e.g., encryption keys and authentication method information) is exchanged between the server and client devices. If a device does not have the appropriate credentials, it is not allowed to connect to the network.

Extensible Authentication Protocol (EAP) is an authentication protocol that is used for securing wireless local area networks (LANs), wired LANs, dial-up connections, and virtual private networks (VPNs). Protected Extensible Authentication Protocol (PEAP) is an extension of EAP that has been developed to provide greater security than EAP. EAP may be vulnerable to several kinds of attacks, such as spoofing and denial of service attacks. To address these problems, PEAP encrypts EAP packets using transport layer security (TLS), a secure socket layer (SSL) based technology.

PEAP and EAP support a variety of authentication methods, such as token cards, Kerberos, public key cryptography, and S/Key. PEAP and EAP provide a framework for negotiating the authentication method used. A device may not support a particular method that a server requests to use. In response, the server and the client device may negotiate a different authentication method.

### SUMMARY OF INVENTION

The inventors have appreciated that it may be desirable to obtain additional information about a device during the authentication process. In one aspect of the invention, parameters of the device are obtained during the authentication process when the device attempts to connect to a network. Obtaining device parameters during the authentication process may enable deciding whether the device should be allowed to connect to the network based on a variety of device parameters.

For example, health parameters related to a device may be exchanged during an authentication session. If a device is healthy, it may be allowed to connect to the network. If the device is not healthy, it may not be allowed to connect to the network.

In another aspect of the invention, both user authentication and machine authentication may be provided. If supported by both devices, user credentials and machine credentials may be exchanged during the authentication session. Providing both user authentication and machine authentication using extensible authentication protocol may enable providing a relatively high level of security.

In one aspect, the invention is related to a method, implemented by a processor, of obtaining information by a first device connected to a network about a second device that is attempting to access the network. The method includes sending, from the first device to the second device, during an authentication session, a communication that requests information representative of an application and/or operating system parameter of the second device. The method also includes receiving, by the first device and from the second device, during the authentication session, the information representative of the application and/or operating system parameter of the second device, if the second device supports sending the information requested by the first device. The method further includes determining, at least partially based on the information representative of the application and/or operating system parameter of the second device, whether to allow the second device access to the network.

In another aspect, the invention is related to a computer-readable medium having computer-executable instructions implemented by a processor for performing steps. The steps include sending, from the first device to the second device, during an authentication session, a communication that requests information representative of a health parameter of the second device. The steps also include receiving, by the first device and from the second device, during the authentication session, the information representative of the health parameter of the second device, if the second device supports sending the information requested by the first device. The steps further include determining, at least partially based on the information representative of the health parameter of the second device, whether to allow the second device access to the network.

In yet another aspect, the invention is related to a method, implemented by a processor, of obtaining information by a first device connected to a network about a second device that is attempting to access the network. The first device and the second device are in communication using extensible authentication protocol. The method includes sending, from the first device to the second device, during an authentication session, a first communication that requests user credentials from the second device. The method also includes sending, from the first device to the second device, during the authentication session, a second communication that requests machine credentials from the second device. The method also includes receiving, by the first device and from the second device, during the authentication session, the user credentials and the machine credentials, if the second device supports sending both the user credentials and the machine credentials. The method further includes determining, at least partially based on the user credentials and the machine credentials received from the second device, whether to allow the second device access to the network.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a diagram illustrating communication between devices during EAP authentication;

FIG. 2 is a diagram illustrating communication between devices during EAP authentication according to embodiments of the invention, including exchanging device parameters; and

FIG. 3 is a diagram illustrating communication between devices during EAP authentication where the client may not support exchanging device parameters during the authentication session.

### DETAILED DESCRIPTION

As discussed above, existing authentication protocols, such as PEAP and EAP, provide an authentication framework in which authentication may be provided using a variety of authentication methods. However, PEAP and EAP do not provide a method for discovering non-authentication capabilities of a client or for exchanging further information with the client. In one aspect, the invention provides for determining further information about the client during an authentication session.

As one example, discovering parameters of a client device during authentication may enable providing network access protection. To prevent the deterioration of network health and security, it may be desirable to prevent devices from connecting to a network that do not have appropriate health parameters. Devices may only be allowed to connect to the network if certain conditions are met related to the health of the devices. For example, a device may not be allowed to connect to the network unless it has an anti-virus program installed and has updated operating system security patches. Preventing unhealthy devices from connecting to the network may enable maintaining network health and security.

Previous systems for providing network access protection prompt the client device for “state of health” information after a connection is already established. However, if a computer or other device is infected with a virus or contains a security flaw, it may not be desirable to give the device access to the network. Determining health information related to the client device during an authentication session may enable providing tighter security than on previous systems.

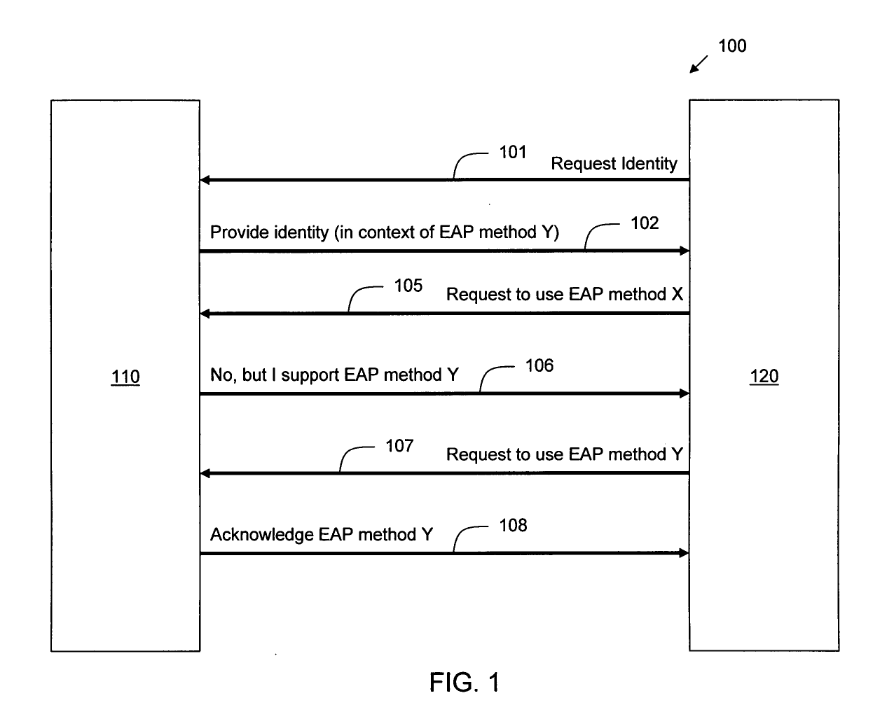

FIG. 1 is a diagram illustrating communication between a client device (client) 110 and a server device (server) 120 during an authentication session 100 according to a prior method of implementing EAP authentication. Authentication session 100 may occur when client 110 is attempting to connect to a network managed by server 120.

Server 120 sends an initial communication 101 to client 110 requesting the identity of client 110. Once client 110 receives communication 101, client 110 responds by sending communication 102 to server 120. Communication 102 includes the identity of the user using client 110. As one example, the identity may be the login user ID for the operating system of device 110. The user's identity may be provided in communication 102 in the context of EAP method Y. Authentication method Y may represent an authentication method, such as token cards, Kerberos, public key cryptography, and S/Key.

Once server 120 receives communication 102, server 120 proposes to use a different EAP authentication method, for example, EAP method X. Server 120 sends communication 105 to client 110 that requests the use of EAP method X. If client 110 supports EAP method X, client 110 responds by indicating that it supports EAP method X. However, in this example, client 110 does not support EAP method X. Accordingly, client 110 sends communication 106 to server 120 indicating that client 110 does not support EAP method X, but does support EAP method Y.

Once server 120 receives communication 106, server 120 may respond by sending communication 107 which requests the use of EAP method Y. Once client 110 receives communication 107, client 110 responds by sending communication 108 to server 120 that acknowledges the use of EAP method Y for the authentication. The authentication then proceeds according to the method negotiated by client 110 and server 120.

In one aspect of the invention, parameters of client 110 may be sent to server 120 during the authentication session. For example, information representative of the health parameters of device 110 may be provided to server 120 during the authentication session.

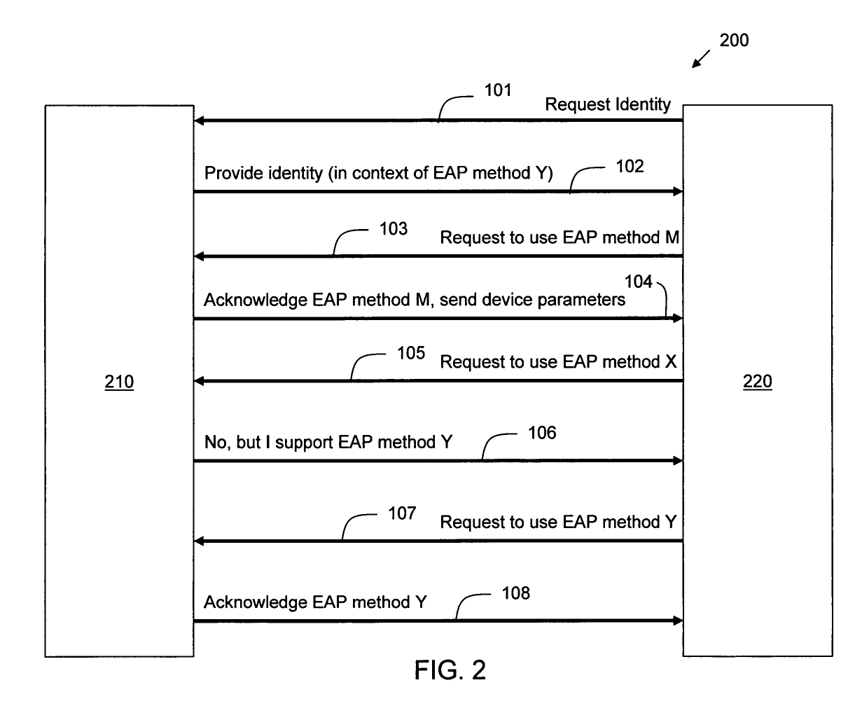

FIG. 2 is a diagram illustrating communication between client 210 and server 220 during an authentication session 200 according to one embodiment of the invention. Authentication session 200 may occur when client 210 is attempting to connect to a network managed by server 220, or at any other suitable time. Authentication session 200 may proceed in accordance with PEAP, EAP and/or any other suitable authentication protocol. If PEAP is used, a secure TLS channel may be established prior to communication 101.

Server 220 may send a communication 101 to client 210 requesting the identity of client 210. Once client 110 receives communication 101, client 210 may respond by sending communication 102 that provides credentials to server 220.

Communication 102 may include machine or user credentials, e.g., the identity of the user using client 110. As one example, the identity may be the login user ID for the operating system of client 210. As another example, machine credentials may be provided, such as the physical address of client 210. The user's identity may be provided in communication 102 in the context of EAP method Y. Authentication method Y may represent one of the authentication methods described above, or any other suitable authentication method.

Once server 220 receives communication 102, server 220 may send a communication 103 that proposes the use of EAP method M. Communication 103 may include a request for information representative of the parameters of client 210. EAP method M may represent a protocol that enables providing parameters of client 210 to server 220 according to aspects of the invention. For example, EAP method M may enable providing information representative of the health of client 210 to server 220.

Once client 210 receives communication 103, client 210 may send communication 104 to server 220. Communication 104 may acknowledge that client 210 supports EAP method M. Communication 104 may include information representative of the parameters of client 210.

Any suitable information representative of the parameters of client 210 may be sent in communication 104. As one example, the information may be representative of health parameters of client 210.

Health parameters of client 210 may include one or more health parameters, such as the status of anti-virus software associated with the client, the status of a firewall associated with the client, the status of operating system security patches associated with the client, or any other suitable health related parameters.

Health parameters of client 210 may be determined in any suitable way. As one example, the health parameters of client 210 may be determined by a software module associated with client 210. The software module may be a network access protection agent associated with client 210 that is operative to interface with health-related software modules to determine health parameters of client 210. For example, the software module may interface with anti-virus software, firewall software and/or the operating system associated with client 210.

The health parameters of client 210 may be represented in any suitable way. For example, the health parameters of client 210 may be represented in TLV (time-length-value) format. TLV information may be sent in communication 104.

The information representative of the parameters of client 210 that is provided to server 220 need not necessarily be representative of health related parameters. Information representative of any other suitable parameters of client 210 may be provided to server 220.

In one aspect of the invention, information representative of parameters of the operating system and/or an application associated with client 210 may be provided to server 220. Examples of parameters of client 210 include the type of operating system associated with client 210, the version of operating system, the type of application associated with client 210, the application version or any other suitable parameters of client 210.

It should be appreciated that the information representative of the parameters of client 210 need not necessarily be provided in communication 104. The information may be sent in one communication or in multiple communications. Further, the information need not necessarily be sent in any particular format. For example, some information may be sent in one format, and some information may be sent in another format.

Server 220 may receive communication 104 that includes the information representative of the parameters of client 210. Once server 220 receives the information, it may take appropriate action. For example, the information may be provided to a software module that determines, based on the information representative of the parameters of device 210, whether device 210 may connect to the network. This determination may be made during authentication session 200, or at any other suitable time.

Server 220 or another device may determine whether device 210 may connect to the network. Any suitable criteria may be used, such as methods known in the art for making this determination or methods developed hereafter. For example, the criteria may be set by a network administrator in accordance with network policy.

Once server 220 receives communication 104, server 220 may send communication 105 to client 210 that requests the use of EAP method X. If client 210 supports EAP method X, client 210 may respond by indicating that it supports EAP method X. However, in this example, client 210 may not support EAP method X. Accordingly, client 210 may send communication 106 to server 220 indicating that client 210 does not support EAP method X, but does support EAP method Y. Communication 106 may be sent using a NAK (Negative AcKnowldgement code) signal, or any other suitable signal for declining the use of an authentication method.

Once server 220 receives communication 106, server 220 may respond by sending communication 107 which requests the use of EAP method Y. Once client 210 receives communication 107, client 210 may respond by sending communication 108 to server 220 that acknowledges the use of EAP method Y for the authentication. The authentication may then proceed according to method Y as negotiated by client 210 and server 220.

Prior EAP and PEAP protocols do not enable providing both machine authentication and user authentication. In one embodiment of the invention, machine authentication and user authentication may be provided in an EAP or PEAP authentication session. Providing both user authentication and machine authentication may enable providing a high level of security.

In one aspect of the invention, machine credentials related to device 120 and user credentials may be provided to server 200 during an authentication session. For example, in session 200 described above, machine credentials may be provided in the context of EAP method M, and user credentials may be provided in the context of EAP method Y. For example, machine credentials may be provided in communication 104. Alternatively, user credentials may be provided in the context of EAP method M, and machine credentials may be provided in the context of EAP method Y. For example, user credentials may be provided in communication 104. The credentials provided in communication 104 may be provided in response to a request for machine and/or user credentials in communication 103.

The techniques described above may enable authentication even if client 210 is not capable of providing the types of information described above to server 220. The techniques may be backwards-compatible with prior systems that do not support the functionality described above with respect to FIG. 2.

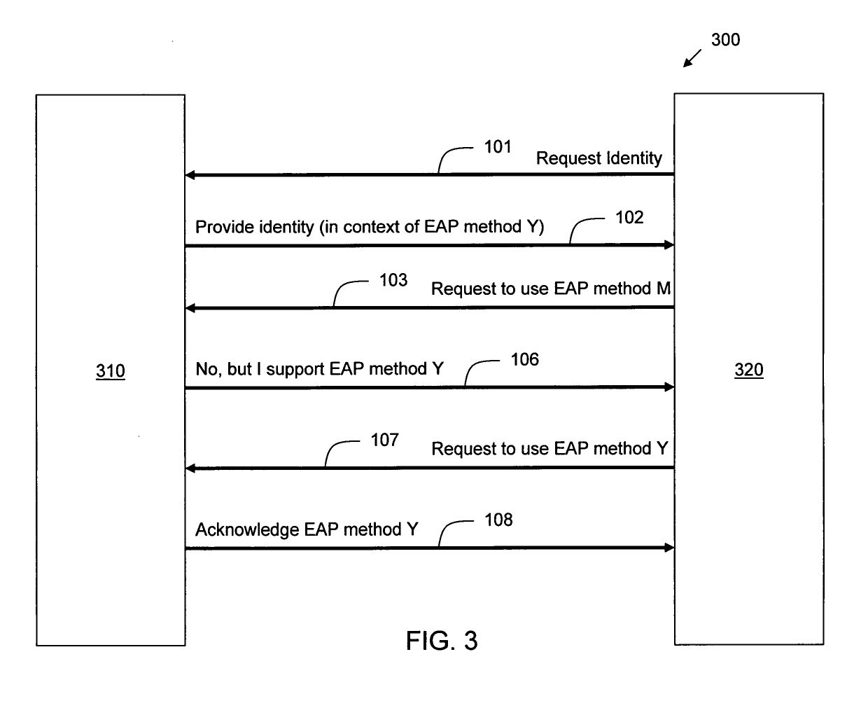

FIG. 3 is a diagram illustrating communication between a client 310 and a server 320 during an authentication session 300. Authentication session 100 may occur when client 310 is attempting to connect to a network managed by server 320, but when client 310 may not support providing additional information during authentication.

Server 320 may send an initial communication 101 to client 310 requesting the identity of client 310. Once client 310 receives communication 101, client 310 may respond by sending communication 102 to server 320. Communication 102 may include the identity of the user using client 310. The user's identity may be provided in communication 102 in the context of EAP method Y. Authentication method Y may represent an authentication method, such as token cards, Kerberos, public key cryptography, and S/Key.

Once server 320 receives communication 102, server 320 may propose that a different EAP authentication method be used, for example, EAP method X. Server 320 may send communication 105 to client 310 that requests the use of EAP method M. However, in this example, client 310 does not support EAP method M. Accordingly, client 310 may send communication 106 to server 320 indicating that client 310 does not support EAP method M, but does support EAP method Y.

Once server 320 receives communication 106, server 320 may respond by sending communication 107 which requests the use of EAP method Y. Once client 310 receives communication 107, client 310 may respond by sending communication 108 to server 320 that acknowledges the use of EAP method Y for the authentication. The authentication then proceeds according to the method negotiated by client 310 and server 320.

The terms “client” and “server” have been used herein merely by way of illustration, but the invention is not limited to being executed by any particular type of hardware. The server may be any suitable device that acts as a network gateway, and need not necessarily be a device that maintains a network. The client may be any suitable device operative to connect to a network. The client may be a general-purpose computer system, as described in further detail below. However, the client need not necessarily be a computer, but may be any other suitable device such as a personal digital assistant, a Bluetooth-enabled device, a cellular phone, a portable music player or a portable video player.

Embodiments of the invention may be implemented on any suitable version of PEAP and/or EAP. For example, PEAP version zero may be used.

Particular ways of implementing aspects of the invention will now be described.

Methods described herein, acts thereof and various embodiments and variations of these methods and acts, individually or in combination, may be defined by computer-readable signals tangibly embodied on one or more computer-readable media, for example, non-volatile recording media, integrated circuit memory elements, or a combination thereof. Computer readable media can be any available media that can be accessed by a computer. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, other types of volatile and non-volatile memory, any other medium which can be used to store the desired information and which can accessed by a computer, and any suitable combination of the foregoing.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, wireless media such as acoustic, RF, infrared and other wireless media, other types of communication media, and any suitable combination of the foregoing.

Computer-readable signals embodied on one or more computer-readable media may define instructions, for example, as part of one or more programs that, as a result of being executed by a computer, instruct the computer to perform one or more of the functions described herein, and/or various embodiments, variations and combinations thereof. Such instructions may be written in any of a plurality of programming languages, for example, Java, J#, Visual Basic, C, C#, C++, Fortran, Pascal, Eiffel, Basic, COBOL, etc., or any of a variety of combinations thereof. The computer-readable media on which such instructions are embodied may reside on one or more of the components of any of systems described herein, may be distributed across one or more of such components, and may be in transition therebetween.

The computer-readable media may be transportable such that the instructions stored thereon can be loaded onto any suitable computer system resource to implement the aspects of the present invention discussed herein. In addition, it should be appreciated that the instructions stored on the computer-readable medium, described above, are not limited to instructions embodied as part of an application program running on a host computer. Rather, the instructions may be embodied as any type of computer code (e.g., software or microcode) that can be employed to program a processor to implement the above-discussed aspects of the present invention.

Various embodiments according to the invention may be implemented on one or more computer systems. These computer systems may be, for example, general-purpose computers such as those based on Intel PENTIUM-type processor, Motorola PowerPC, Sun UltraSPARC, Hewlett-Packard PA-RISC processors, or any other type of processor. Further, the embodiments may be located on a single computer or may be distributed among a plurality of computers attached by a communications network.

For example, various aspects of the invention may be implemented as specialized software executing in a general-purpose computer system. The computer system may include a processor connected to one or more memory devices, such as a disk drive, memory, or other device for storing data. Memory is typically used for storing programs and data during operation of the computer system. Components of the computer system may be coupled by an interconnection mechanism, which may include one or more busses (e.g., between components that are integrated within a same machine) and/or a network (e.g., between components that reside on separate discrete machines). The interconnection mechanism enables communications (e.g., data, instructions) to be exchanged between system components. The computer system also includes one or more input devices, for example, a keyboard, mouse, trackball, microphone, touch screen, and one or more output devices, for example, a printing device, display screen, speaker. In addition, the computer system may contain one or more interfaces that connect the computer system to a communication network (in addition or as an alternative to the interconnection mechanism.

The storage system typically includes a computer readable and writeable nonvolatile recording medium in which signals are stored that define a program to be executed by the processor or information stored on or in the medium to be processed by the program. The medium may, for example, be a disk or flash memory. Typically, in operation, the processor causes data to be read from the nonvolatile recording medium into another memory that allows for faster access to the information by the processor than does the medium. This memory is typically a volatile, random access memory such as a dynamic random access memory (DRAM) or static memory (SRAM). It may be located in the storage system, or in the memory system. The processor generally manipulates the data within the integrated circuit memory and then copies the data to the medium after processing is completed. A variety of mechanisms are known for managing data movement between the medium and the integrated circuit memory element and the invention is not limited thereto. The invention is not limited to a particular memory system or storage system.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although the computer system discussed by way of example as one type of computer system upon which various aspects of the invention may be practiced, it should be appreciated that aspects of the invention are not limited to being implemented on the computer system. Various aspects of the invention may be practiced on one or more computers having a different architecture or components.

The computer system may be a general-purpose computer system that is programmable using a high-level computer programming language. The computer system may be also implemented using specially programmed, special purpose hardware. In the computer system, the processor is typically a commercially available processor such as the well-known Pentium class processor available from the Intel Corporation. Many other processors are available. Such a processor usually executes an operating system which may be, for example, the Windows Server™ 2003, Windows® 95, Windows® 98, Windows NT®, Windows® 2000, Windows® ME, or Windows® XP operating systems available from Microsoft Corporation, MAC OS System X available from Apple Computer, the Solaris Operating System available from Sun Microsystems, UNIX available from various sources or Linux available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems coupled to communications network 100. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

Network 100 may be any suitable type of network such a local area network (LAN), wide area network (WAN), intranet, Internet or any combination thereof. For illustrative purposes, a limited number of devices are shown in this example. However, it is to be appreciated that many devices may be coupled to network 100. Although the devices are illustrated as being coupled directly to the network 100, the devices may be coupled to the network through one or more servers, routers, proxies, gateways, network address translation devices or any suitable combination thereof.

It should be appreciated that the invention is not limited to executing on any particular system or group of systems. Also, it should be appreciated that the invention is not limited to any particular distributed architecture, network, or communication protocol.

Various embodiments of the present invention may be programmed using an object-oriented programming language, such as SmallTalk, Java, C++, Ada, J# (J-Sharp) or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program render aspects of a graphical-user interface (GUI) or perform other functions). Various aspects of the invention may be implemented as programmed or non-programmed elements, or any combination thereof.

Having now described some illustrative embodiments of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention. In particular, although many of the examples presented herein involve specific combinations of method acts or system elements, it should be understood that those acts and those elements may be combined in other ways to accomplish the same objectives. Acts, elements and features discussed only in connection with one embodiment are not intended to be excluded from a similar role in other embodiments. Further, for the one or more means-plus-function limitations recited in the following claims, the means are not intended to be limited to the means disclosed herein for performing the recited function, but are intended to cover in scope any equivalent means, known now or later developed, for performing the recited function.

Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A method, implemented by a processor, of obtaining information by a first device connected to a network about a second device that is attempting to access the network, the method comprising:
sending, from the first device to the second device, during an authentication session, a communication that requests information representative of an application and/or operating system parameter of the second device;
receiving, by the first device and from the second device, during the authentication session, the information representative of the application and/or operating system parameter of the second device, if the second device supports sending the information requested by the first device; and
determining, at least partially based on the information representative of the application and/or operating system parameter of the second device, whether to allow the second device access to the network.

2. The method of claim 1, wherein the information representative of the application and/or operating system parameter of the second device comprises health information related to the second device.

3. The method of claim 2, wherein the health information comprises information about a status of antivirus software associated with the second device.

4. The method of claim 2, wherein the health information comprises information about a status of operating system security updates of an operating system associated with the second device.

5. The method of claim 2, wherein the health information comprises information about a status of a firewall associated with the second device.

6. The method of claim 1, wherein the application and/or operating system parameter of the second device comprises information related to an application associated with the second device.

7. The method of claim 1, wherein the application and/or operating system parameter of the second device comprises information related to an operating system associated with the second device.

8. The method of claim 1, wherein the authentication session is provided in accordance with extensible authentication protocol.

9. The method of claim 1, wherein the authentication session is provided in accordance with protected extensible authentication protocol.

10. A computer-readable medium having computer-executable instructions implemented by a processor for performing steps comprising:
sending, from the first device to the second device, during an authentication session, a communication that requests information representative of a health parameter of the second device;
receiving, by the first device and from the second device, during the authentication session, the information representative of the health parameter of the second device, if the second device supports sending the information requested by the first device; and
determining, at least partially based on the information representative of the health parameter of the second device, whether to allow the second device access to the network.

11. The computer-readable medium of claim 10, wherein the health information comprises information about a status of antivirus software associated with the second device.

12. The computer-readable medium of claim 10, wherein the health information comprises information about a status of operating system security updates of an operating system associated with the second device.

13. The computer-readable medium of claim 10, wherein the health information comprises information about a status of a firewall associated with the second device.

14. The computer-readable medium of claim 10, wherein the authentication session is provided in accordance with extensible authentication protocol.

15. The computer-readable medium of claim 10, wherein the authentication session is provided in accordance with protected extensible authentication protocol.

16. A method, implemented by a processor, of obtaining information by a first device connected to a network about a second device that is attempting to access the network, the first device and the second device being in communication using extensible authentication protocol, the method comprising:
sending, from the first device to the second device, during an authentication session, a first communication that requests user credentials from the second device;
sending, from the first device to the second device, during the authentication session, a second communication that requests machine credentials from the second device;
receiving, by the first device and from the second device, during the authentication session, the user credentials and the machine credentials, if the second device supports sending both the user credentials and the machine credentials; and
determining, at least partially based on the user credentials and the machine credentials received from the second device, whether to allow the second device access to the network.

17. The method of claim 16, further comprising:
providing user authentication and machine authentication during the authentication session if the user device supports providing user credentials and machine credentials using the extensible authentication protocol during the authentication session.

18. The method of claim 16, further comprising:
providing user authentication or machine authentication session if the device does not support providing user credentials and machine credentials using the extensible authentication protocol during the authentication session.

19. The method of claim 16, wherein the authentication session is provided in accordance with protected extensible authentication protocol.

20. The method of claim 16, wherein the authentication session is provided in accordance with protected extensible authentication protocol, version zero.
